(19) United States
(12) Patent Application Publication
(10) Pub. No.: US 2015/0185554 A1
(43) Pub. Date: Jul. 2, 2015

(54) LIQUID CRYSTAL DISPLAY AND METHOD FOR MANUFACTURING THE SAME

(71) Applicant: SHENZHEN CHINA STAR OPTOELECTRONICS TECHNOLOGY CO. LTD., Shenzhen, Guangdong (CN)

(72) Inventors: Yong Zhao, Shenzhen (CN); Liren Ouyang, Shenzhen (CN); Juan Liu, Shenzhen (CN); Yongji Zhang, Shenzhen (CN)

(21) Appl. No.: 14/241,404

(22) PCT Filed: Jan. 23, 2014
(86) PCT No.: PCT/CN14/71267

§ 371 Date: Jun. 3, 2014

(30) Foreign Application Priority Data
Dec. 31, 2013 (CN) 201310750936.1

(51) Int. Cl. G02F 1/1335

(52) U.S. Cl. CPC G02F 1/133528; G02F 1/133514

(57) ABSTRACT

The present disclosure relates to liquid crystal displays, particularly a liquid crystal display panel and a method for manufacturing the same. The liquid crystal display panel according to the present disclosure includes an array substrate, a color filter substrate, and a liquid crystal layer between the array substrate and the color filter substrate, wherein a polarizer is arranged on one side of the color filter substrate away from the liquid crystal layer and provided with a polarizing film layer for filtering the polarizing direction of light and a phase retardation film layer fixed on the polarizing film layer, and the phase retardation film layer is made of triacetate cellulose, and can convert linearly polarized light entering the phase retardation film layer into circularly polarized light. The method of the present disclosure at least including the following steps: step 1, manufacturing a phase retardation film layer by using triacetate cellulose as a base material; step 2, performing surface treatment on the phase retardation film layer; and step 3, fixing the phase retardation film layer on a polarizing film layer to form a polarizer. According to the present disclosure, the thickness of the panel can be reduced.

### FIELD OF THE INVENTION

The present disclosure relates to the technical field of liquid crystal display, and particularly, relates to a liquid crystal display panel and a method for manufacturing the same.

### BACKGROUND OF THE INVENTION

The relationship between polarized light and visual fatigue of human eyes receiving the polarized light has been studied in the document “Evaluation of the Influence of Polarization Characteristics of Liquid Crystal Television on Visual Fatigue with Blink Rate”.

In this document, the influence of linearly polarized light and circularly polarized light emitted by the liquid crystal television on the visual fatigue are compared with each other. 64 cases of normal persons are randomly divided into two groups, with 32 cases each group, to watch a feature movie played by a liquid crystal television of which emits the linearly polarized light or the circularly polarized light for 125 min respectively. The blink rates before, during and after watching the feature movie are recorded by using electro-oculograms (EOG), and the variation characteristics of the blink rates are analyzed and compared. As a result, the blink rate after the linearly polarized light group watches the feature movie is higher than that before watching, and the difference has statistical significance (P<0.01). In contrast, the difference of the blink rates before and after the circularly polarized light group watches the feature movie does not have the statistical significance (P>0.05). It is thus concluded from the document that the visual fatigue is easily caused when the liquid crystal television with the linearly polarized light is watched for long time compared with the liquid crystal television with the circularly polarized light.

Therefore, if a display device can be improved to emit circularly polarized light which is more comfortable for human eyes, a considerable progress can be achieved.

A ¼ wave plate is an optical sheet for generating and checking circularly polarized light or elliptically polarized light. Suppose that a parallel beam is in normal incidence, the beam advances straightly in the wave plate and then is transmitted. The propagation speeds of two characteristic vibrations Eₒ(t) and Eₑ(t) on the transverse plane are vₒ and vₑ respectively. Although the light passes through the same thickness, the optical paths Lₒ and Lₑ are not equal to each other. In other words, through the wave plate, an additional phase difference is generated between Eₒ(t) and Eₑ(t), namely phase retardation is caused.

FIG. 1 shows a liquid crystal display panel which can finally emit circularly polarized light in the prior art.

With reference to FIG. 1, the panel includes an array substrate 1, a color filter substrate 2, and a liquid crystal layer 3 between the array substrate 1 and the color filter substrate 2, wherein a front polarizer 4 is arranged on one side of the color filter substrate 2 away from the liquid crystal layer 3, a rear polarizer 5 is arranged on one side of the array substrate 1 away from the liquid crystal layer 3, and a quarter-wavelength wave plate 6 is arranged on one side of the front polarizer 4 away from the liquid crystal layer 3 and configured to convert linearly polarized light from the front polarizer 4 into circularly polarized light. With reference to a detail view on the upper portion of FIG. 1, the quarter-wavelength wave plate 6 is bonded to the front polarizer 4 through an adhesive layer 7. The quarter-wavelength wave plate 6 can be made of cyclo-olefin polymer (COP) or polycarbonate (PC).

However, in consideration of practical application of a liquid crystal display device, anti-halation and anti-reflection functions and the like are also needed. Accordingly, an anti-glare layer 8, an anti-reflection layer 9 and the like should be also bonded outside the quarter-wavelength wave plate 6. If a physical anti-scratch function needs to be provided, an anti-scratch diaphragm not shown in FIG. 1 should be also provided. It could be seen from the detail view in FIG. 1 that in this liquid crystal display device of the prior art, at least four layers (at least five layers are needed if the anti-scratch function is included) are arranged outside the front polarizer 4. This significantly increases the thickness of the liquid crystal panel, the operation time and complexity of manufacturing process, and the consumption of manufacturing materials. In addition, the quarter-wavelength wave plate made of COP or PC has many layers and is thick, which is not favorable for the development of the liquid crystal panel towards thinness, lightweight and low cost.

### SUMMARY OF THE INVENTION

In conclusion, in a liquid crystal display device of the prior art, at least five layers are arranged outside a front polarizer, which greatly increases the thickness of a liquid crystal panel, the operation time and complexity of a manufacturing process, and the consumption of manufacturing materials. In addition, a quarter-wavelength wave plate made of COP or PC has many layers and is thick, which is not favorable for the development of the liquid crystal panel towards thinness, lightweight and low cost.

Aiming at the above-mentioned shortcomings, the present disclosure therefore proposes an improved liquid crystal display panel.

The liquid crystal display panel according to the present disclosure includes an array substrate, a color filter substrate, and a liquid crystal layer between the array substrate and the color filter substrate, a polarizer being arranged on one side of the color filter substrate away from the liquid crystal layer, wherein the polarizer is provided with a polarizing film layer for filtering the polarizing direction of light and a phase retardation film layer fixed on the polarizing film layer, and wherein the phase retardation film layer is made of triacetate cellulose (TAC), and can convert linearly polarized light entering the phase retardation film layer into circularly polarized light.

As explained in the background portion of the present disclosure, the circularly polarized light enables a viewer to feel comfortable for eyes, and may effectively relieve visual fatigue and protect the health of the eyes, compared with the linearly polarized light.

Preferably, the optical axis of the phase retardation film layer and the transmission axis of the polarizing film layer form an angle of 45° therebetween, and the phase retardation film layer can perform quarter-wavelength effective phase retardation on the light passing through the phase retardation film layer.

The light from the polarizing film layer is linearly polarized light, and the polarizing direction of the light and the optical axis of the phase retardation film layer form an angle of 45° therebetween. After the light enters the phase retardation film layer, the light can be divided into two vibration components, i.e., one in the direction vertical to the optical axis of the phase retardation film layer and one in the direction parallel to the optical axis of the phase retardation film layer, namely Eₒt) and Eₑt) respectively. After the light passes through the phase retardation film layer, a quarter-wavelength effective phase difference (because the cycle of each phase is 2π, the phase differences having a difference of integral multiples of a are equivalent to each other in optical effect, and thus the really effective phase difference is actually only ±π/2) is generated between the phases of the two vibration components. Thus, the light emitted from the phase retardation film layer is circularly polarized light.

On the other hand, compared with many other materials, the chemical and physical properties of the TAC result in that the optical, physical and chemical properties of the phase retardation film layer made of the TAC are very stable. This determines that a certain processing treatments (such as coating, drying treatment, curing treatment and the like) may be performed on the surface of the phase retardation film layer without destroying the optical property and the mechanical property of the phase retardation film layer. After a certain treatments are preformed on the surface of the phase retardation film layer, the shape, optical axis arrangement direction and phase retardation function of the film layer are still retained.

Preferably, the phase retardation film layer also has at least one of an anti-glare material, an anti-reflection material and an anti-scratch material. Preferably, at least one of the anti-glare material, the anti-reflection material and the anti-scratch material is arranged on the surface of the phase retardation film layer through coating. Thus, compared with at least six diaphragms in the prior art, functions of polarization, phase retardation, anti-glare, anti-reflection and anti-scratch can be realized through only one film layer according to the present disclosure. The thickness, material consumption and production process complexity of the liquid crystal panel are thus greatly reduced.

The present disclosure also proposes a method for manufacturing a liquid crystal display panel, at least including the following steps: step 1, manufacturing a phase retardation film layer by using triacetate cellulose as a base material, wherein the optical axis of the phase retardation film layer extends towards a first direction, and the phase retardation film layer can perform quarter-wavelength effective phase retardation on light passing through the phase retardation film layer at the same time; step 2, performing surface treatment on the phase retardation film layer, so that the phase retardation film layer has at least one of anti-glare, anti-reflection and anti-scratch functions; and step 3, fixing the phase retardation film layer on a polarizing film layer to form a polarizer, wherein the first direction and the transmission axis direction of the polarizing film layer form an angle of 45° therebetween.

Particularly, with regard to the complexity of process steps, in the prior art, the polarization function, phase retardation function, anti-glare function, anti-reflection function and anti-scratch function have to be realized by producing different optical diaphragms at different sites or through different manufacturers respectively, and then assembling the optical diaphragms together. The whole process is very fussy, and operational time and costs are very high. Meanwhile, the compatibility, stability, adaptability and the like of the optical diaphragms produced on different production lines must be strictly screened and adjusted. Whereas in the method of the present disclosure, the above-mentioned multiple functions are integrated into one polarizer in a straight process flow, so that the time, manpower and costs of procedures of assembling, screening, adaption, and the like, are greatly reduced, and a significant progress is brought.

Preferably, step 2 includes the following substeps: substep 21, cleaning the phase retardation film layer; substep 22, coating at least one of an anti-glare material, an anti-reflection material and an anti-scratch material on the surface of the phase retardation film layer; and substep 23, performing drying and hardening treatment on the material coated in the substep 22. Preferably, the hardening treatment is performed through an ultraviolet curing process or a heat curing process.

Because the properties of the triacetate cellulose are very stable, a certain processing treatments (such as coating, drying treatment, curing treatment and the like) may be performed on the surface of the phase retardation film layer, without destroying the optical property and the mechanical property of the phase retardation film layer. After a certain treatments are performed on the surface of the phase retardation film layer, the shape, optical axis arrangement direction and phase retardation function of the film layer are still retained.

Preferably, the polarizing film layer may be manufactured by using polyvinyl alcohol (PVA). PVA is most suitable for manufacturing the polarizing film layer due to the properties thereof, and is easy to obtain and low in cost at the same time.

In an example, the first direction and at least a first edge of the phase retardation film layer extending straightly form an angle of 45° therebetween, so that the transmission axis direction of the polarizing film layer is parallel or vertical to at least a second edge of the polarizing film layer extending straightly. And when the phase retardation film layer is fixed on the polarizing film layer, the first edge is parallel to the second edge. In such a manner, when the phase retardation film layer is fixed on the polarizing film layer, it is only necessary to align and cut the edges in fact, so that the operation is simple, the error is low, and the yield of products is improved.

In another example, the first direction of the phase retardation film layer is marked, and the transmission axis direction of the polarizing film layer is marked also. When the phase retardation film layer is fixed on the polarizing film layer, the first direction and the transmission axis direction of the polarizing film layer form an angle of 45° therebetween. In such a manner, the phase retardation film layer may be freely cut to adapt to liquid crystal panels of different models. Therefore, the loss of materials is reduced, and the production cost is reduced at the same time.

According to the present disclosure, the properties of the triacetate cellulose material are utilized intentionally, wherein the triacetate cellulose material is used to manufacture the phase retardation film layer, and the surface of the phase retardation film layer is subjected to suitable processing treatments. Therefore, functions of polarization, phase retardation, anti-glare, anti-reflection and anti-scratch can be realized only through the polarizer itself of the liquid crystal panel. The thickness, material consumption and production process complexity of the liquid crystal panel are thus greatly reduced.

The above-mentioned technical features may be combined together in various appropriate manners or substituted by equivalent technical features, as long as the objective of the present disclosure can be fulfilled.

### BRIEF DESCRIPTION OF THE DRAWINGS

The present disclosure will be described in more detail below based on merely nonfinite examples with reference to the accompanying drawings. Wherein:

FIG. 1 shows a liquid crystal display panel in the prior art, wherein the upper portion of the drawing is an amplified schematic diagram of the circled portion therein; and

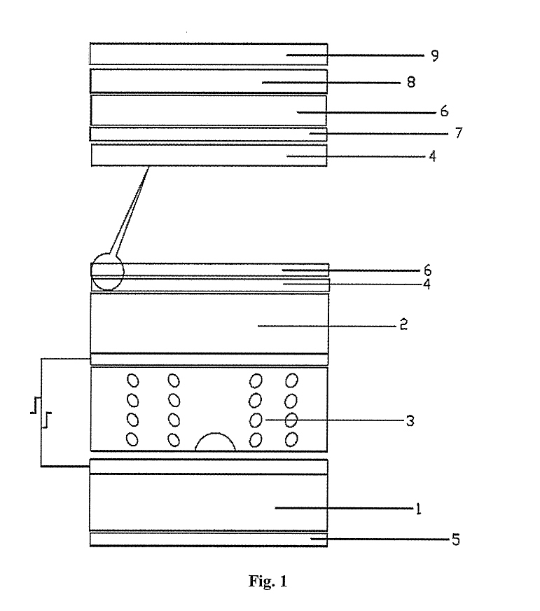

FIG. 2 shows a liquid crystal display panel according to the present disclosure, wherein the upper portion of the drawing is an amplified schematic diagram of the circled portion therein.

In the drawings, the same components are indicated by the same reference signs. The accompanying drawings are not drawn in an actual scale.

### DETAILED DESCRIPTION OF THE EMBODIMENTS

The present disclosure will be introduced in detail below with reference to the accompanying drawings.

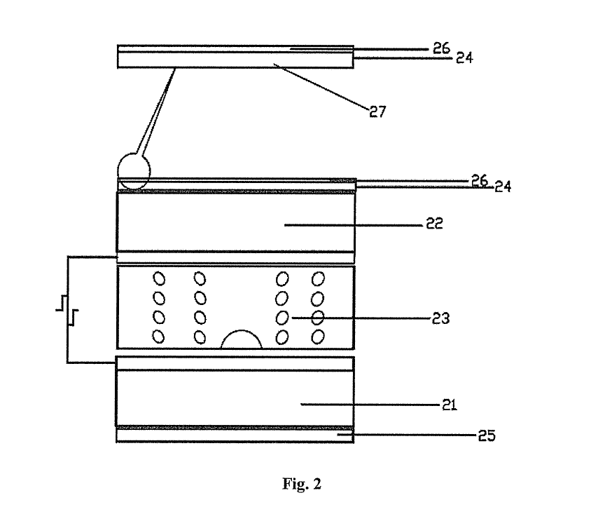

FIG. 2 shows a liquid crystal display panel according to the present disclosure.

With reference to FIG. 2, the liquid crystal display panel according to the present disclosure includes an array substrate 21, a color filter substrate 22, and a liquid crystal layer 23 between the array substrate 21 and the color filter substrate 22. A polarizer 24 is arranged on one side of the color filter substrate 22 away from the liquid crystal layer 23, and a polarizer 25 is arranged on one side of the array substrate 21 away from the liquid crystal layer 23.

In the liquid crystal display panel according to the present disclosure, the polarizer 24 is provided with a polarizing film layer 27 for filtering the polarizing direction of light, and a phase retardation film layer 26 fixed on the polarizing film layer 27.

The phase retardation film layer 26 is made of triacetate cellulose, and can convert linearly polarized light entering the phase retardation film layer 26 into circularly polarized light. It has been explained in the background of the present disclosure that the circularly polarized light can enable a viewer to feel comfortable for eyes, and may effectively relieve visual fatigue and thus protect the health of the eyes, compared with the linearly polarized light.

In an example shown in FIG. 2, the optical axis of the phase retardation film layer 26 and the transmission axis of the polarizing film layer 27 form an angle of 45° therebetween, and the phase retardation film layer 26 can perform a quarter-wavelength effective phase retardation on the light passing through the phase retardation film layer 26. The light from the polarizing film layer 27 is linearly polarized light, and the polarizing direction of the light and the optical axis of the phase retardation film layer 26 form an angle of 45° therebetween. After the light enters the phase retardation film layer 26, the light can be divided into two vibration components, i.e., one in the direction vertical to the optical axis of the phase retardation film layer 26 and one in the direction parallel to the optical axis of the phase retardation film layer 26, namely Eₒ(t) and Eₑ(t) respectively. After the light passes through the phase retardation film layer 26, an quarter-wavelength effective phase difference (because the cycle of each phase is 2π, the phase differences having a difference of integral multiples of 2π are equivalent to each other in optical effect, and thus the really effective phase difference is actually only ±π/2) is generated between the phases φₒ and φₑ of the two vibration components. Thus, the light emitted from the phase retardation film layer 26 is circularly polarized light.

On the other hand, compared with many other materials, the chemical and physical properties of the triacetate cellulose result in that the optical, thermal, physical and chemical properties of the phase retardation film layer 26 made of the triacetate cellulose are very stable. This determines that a certain processing treatments (such as coating, drying treatment, curing treatment, and the like) may be performed on the surface of the phase retardation film layer 26, without destroying the optical property and the mechanical property of the phase retardation film layer 26. After a certain treatments are performed on the surface of the film layer, the shape, optical axis arrangement direction, and phase retardation function of the film layer are still retained.

Thus, in order that the manufactured liquid crystal panel can be better applied to actual display, the phase retardation film layer 26 also has at least one of an anti-glare material, an anti-reflection material and an anti-scratch material. The anti-glare material, the anti-reflection material and the anti-scratch material may be arranged on the surface of the phase retardation film layer 26 through coating.

Thus, compared with at least six film layers in the prior art, according to the present disclosure, the functions of polarization, phase retardation, anti-glare, anti-reflection and anti-scratch can be realized through only one component, namely the polarizer 24. The thickness, material consumption, and production process complexity of the liquid crystal panel are thus greatly reduced.

The present disclosure also proposes a method for manufacturing a liquid crystal display panel, at least including the following steps:

Step 1, manufacturing a phase retardation film layer 26 by using triacetate cellulose as a base material, wherein the optical axis of the phase retardation film layer 26 extends towards a first direction, and the phase retardation film layer 26 can perform quarter-wavelength effective phase retardation on light passing through the phase retardation film layer 26 at the same time.

Step 2, performing surface treatment on the phase retardation film layer 26, so that the phase retardation film layer 26 has at least one of anti-glare, anti-reflection and anti-scratch functions.

Preferably, step 2 includes the following substeps: substep 21, cleaning the phase retardation film layer 26; substep 22, coating at least one of an anti-glare material, an anti-reflection material and an anti-scratch material on the surface of the phase retardation film layer 26; and substep 23, performing drying and hardening treatment on the material coated in the substep 22. The hardening treatment may be performed through an ultraviolet curing process or a heat curing process.

Step 3, fixing the phase retardation film layer 26 on a polarizing film layer 27 to form a polarizer 24, wherein the first direction and the transmission axis direction of the polarizing film layer 27 form an angle of 45° therebetween.

It is thus clear that in the method according to the present disclosure, the polarization function, phase retardation function, anti-glare function, anti-reflection function and anti-scratch function can be incorporated in the polarizer 24 through a series of process steps. Compared with the prior art, the thickness, material consumption and production process complexity of the liquid crystal panel are therefore greatly reduced.

Particularly, with regard to the complexity of process steps, in the prior art, the polarization function, phase retardation function, anti-glare function, anti-reflection function and anti-scratch function have to be realized by producing different optical diaphragms at different sites or through different manufacturers respectively, and then assembling the optical diaphragms together. The whole process is very fussy, and operational time and costs thereof are very high. Meanwhile, the compatibility, stability, adaptability and the like of the optical diaphragms produced on different production lines must be strictly screened and adjusted. Whereas in the method of the present disclosure, the above-mentioned multiple functions are integrated into the polarizer 24 in a straight process flow, so that the time, manpower and costs of procedures of assembling, screening, adaption, and the like, are greatly reduced, and a significant progress is brought.

The angle of 45° between the optical axis of the phase retardation film layer 26 and the transmission axis of the polarizing film layer 27 may be formed according to the following two embodiments.

In one embodiment, the first direction and at least one first edge of the phase retardation film layer 26 form the angle of 45° therebetween. Meanwhile, the transmission axis direction of the polarizing film layer 27 is parallel or vertical to at least one second edge of the polarizing film layer 27 extending straightly. And when the phase retardation film layer 26 is fixed on the polarizing film layer 27, the first edge is parallel to the second edge. In such a manner, when the phase retardation film layer 26 is fixed on the polarizing film layer 27, it is only necessary to align and cut the edges, so that the operation is simple, the error is low, and the yield of products is improved.

In the other embodiment, the first direction of the phase retardation film layer 26 is marked, and the transmission axis direction of the polarizing film layer 27 is marked. When the phase retardation film layer 26 is fixed on the polarizing film layer 27, the first direction and the transmission axis direction of the polarizing film layer 27 form an angle of 45° therebetween. In such a manner, the phase retardation film layer 26 may be freely cut to adapt to liquid crystal panels of different models. Therefore, the loss of materials is reduced, and the production cost is reduced at the same time.

Preferably, the polarizing film layer 27 can be manufactured by using polyvinyl alcohol (PVA). PVA is suitable for manufacturing optical components for polarizing due to the properties thereof

According to the present disclosure, the functions of polarization, phase retardation, anti-glare, anti-reflection and anti-scratch can be realized through only one component, namely the polarizer 24. The thickness, material consumption and production process complexity of the liquid crystal panel are thus greatly reduced.

Although the present disclosure has been described with reference to the preferred examples, various modifications could be made to the present disclosure without departing from the scope of the present disclosure and components in the present disclosure could be substituted by equivalents. The present disclosure is not limited to the specific examples disclosed in the description, but includes all technical solutions falling into the scope of the claims.

1. A liquid crystal display panel, including an array substrate, a color filter substrate, and a liquid crystal layer between the array substrate and the color filter substrate, a polarizer being arranged on one side of the color filter substrate away from the liquid crystal layer,
wherein the polarizer is provided with a polarizing film layer for filtering the polarizing direction of light, and a phase retardation film layer fixed on the polarizing film layer, and
the phase retardation film layer is made of triacetate cellulose, and can convert linearly polarized light entering the phase retardation film layer into circularly polarized light.

2. The liquid crystal display panel according to claim 1, wherein the optical axis of the phase retardation film layer and the transmission axis of the polarizing film layer form an angle of 45° therebetween, and the phase retardation film layer can perform quarter-wavelength effective phase retardation on the light passing through the phase retardation film layer.

3. The liquid crystal display panel according to claim 1, wherein the phase retardation film layer further has at least one of an anti-glare material, an anti-reflection material and an anti-scratch material.

4. The liquid crystal display panel according to claim 2, wherein the phase retardation film layer further has at least one of an anti-glare material, an anti-reflection material and an anti-scratch material.

5. The liquid crystal display panel according to claim 3, wherein at least one of the anti-glare material, the anti-reflection material and the anti-scratch material is arranged on the surface of the phase retardation film layer through coating.

6. The liquid crystal display panel according to claim 4, wherein at least one of the anti-glare material, the anti-reflection material and the anti-scratch material is arranged on the surface of the phase retardation film layer through coating.

7. A method for manufacturing a liquid crystal display panel, at least including the following steps:
step 1, manufacturing a phase retardation film layer by using triacetate cellulose as a base material, wherein the optical axis of the phase retardation film layer extends towards a first direction, and the phase retardation film layer can perform quarter-wavelength effective phase retardation on light passing through the phase retardation film layer at the same time;
step 2, performing surface treatment on the phase retardation film layer, so that the phase retardation film layer has at least one of anti-glare, anti-reflection and anti-scratch functions; and
step 3, fixing the phase retardation film layer on a polarizing film layer to form a polarizer, wherein the first direction and the transmission axis direction of the polarizing film layer form an angle of 45° therebetween.

8. The method according to claim 7, wherein step 2 includes the following substeps:
substep 21, cleaning the phase retardation film layer;
substep 22, coating at least one of an anti-glare material, an anti-reflection material and an anti-scratch material on the surface of the phase retardation film layer; and
substep 23, performing drying and hardening treatment on the material coated in the substep 22.

9. The method according to claim 8, wherein the hardening treatment is performed through an ultraviolet curing process or a heat curing process.

10. The method according to claim 7, wherein the polarizing film layer may be manufactured by using polyvinyl alcohol.

11. The method according to claim 8, wherein the polarizing film layer may be manufactured by using polyvinyl alcohol.

12. The method according to claim 9, wherein the polarizing film layer may be manufactured by using polyvinyl alcohol.

13. The method according to claim 7, wherein further including:
arranging the first direction and at least one first edge of the phase retardation film layer extending straightly to form an angle of 45° therebetween, so that the transmission axis direction of the polarizing film layer is parallel or vertical to at least one second edge of the polarizing film layer extending straightly; and
enabling the first edge being parallel to the second edge when the phase retardation film layer is fixed on the polarizing film layer.

14. The method according to claim 8, wherein further including:
arranging the first direction and at least one first edge of the phase retardation film layer extending straightly to form an angle of 45° therebetween, so that the transmission axis direction of the polarizing film layer is parallel or vertical to at least one second edge of the polarizing film layer extending straightly; and
enabling the first edge being parallel to the second edge when the phase retardation film layer is fixed on the polarizing film layer.

15. The method according to claim 9, wherein further including:
arranging the first direction and at least one first edge of the phase retardation film layer extending straightly to form an angle of 45° therebetween, so that the transmission axis direction of the polarizing film layer is parallel or vertical to at least one second edge of the polarizing film layer extending straightly; and
enabling the first edge being parallel to the second edge when the phase retardation film layer is fixed on the polarizing film layer.

16. The method according to claim 7, wherein further including:
marking the first direction of the phase retardation film layer and the transmission axis direction of the polarizing film layer respectively; and
arranging the first direction and the transmission axis direction of the polarizing film layer to form an angle of 45° therebetween, when the phase retardation film layer is fixed on the polarizing film layer.

17. The method according to claim 8, wherein further including:
marking the first direction of the phase retardation film layer and the transmission axis direction of the polarizing film layer respectively; and
arranging the first direction and the transmission axis direction of the polarizing film layer to form an angle of 45° therebetween, when the phase retardation film layer is fixed on the polarizing film layer.

18. The method according to claim 9, wherein further including:
marking the first direction of the phase retardation film layer and the transmission axis direction of the polarizing film layer respectively; and
arranging the first direction and the transmission axis direction of the polarizing film layer to form an angle of 45° therebetween, when the phase retardation film layer is fixed on the polarizing film layer.
